(19) United States
(12) Patent Application Publication
(10) Pub. No.: US 2007/0220790 A1
(43) Pub. Date: Sep. 27, 2007

(54) Device Provided with a Wind Surface

(76) Inventor: Hendrik Sjirk Wagter, Doorn (NL)

Correspondence Address: LADAS & PARRY, 26 WEST 61ST STREET, NEW YORK, NY, 10023, US

(21) Appl. No.: 10/580,280

(22) PCT Filed: Nov. 25, 2004
(86) PCT No.: PCT/NL04/00817

§ 371 Date: Mar. 2, 2007

(30) Foreign Application Priority Data
Nov. 25, 2003 (NL) 1024865

(51) Int. Cl. G09F 17/00

(52) U.S. Cl. 40/218

(57) ABSTRACT

The invention relates to a device or to an assembly comprising one or more devices, wherein the device comprises a carrier, preferably an information carrier, and a holder for the information carrier, wherein the information carrier comprises a display for displaying changing and/or moving images and wherein the display at least partially forms a wind surface for under the influence of the wind moving at least the wind surface, wherein the device comprises control means for controlling the display. Preferably the device further comprises means for generating electric power from a motion of the wind surface.

The invention relates to a device, particularly an information device, provided with a wind surface. The invention particularly relates to a flag, a rotor, a signboard, banner or a vane.

Up until now signboards, flags or rotors have often been used as a communication means.

Flags or banners suspended from flagpoles, usually vertical poles, are a popular means of communication used by authorities as well as organisations. Because flags have of old been used for formal purposes and are associated with gentry and national identity, they exude elegance, grandeur and class.

Contrary to flags and banners, signboards are usually suspended from horizontally placed banner arms, and they are a popular means of communication for the retail trade.

Also rotors, usually placed so as to be rotatable about a vertical axis to be driven by the wind in a rotary motion about a vertical axis, are used as a means of communication. The visible (vertical) surfaces of the rotor are for instance provided with an advertisement.

Due to being exposed to the wind, flags, signboards and rotors are brought into motion as a result of which they draw the attention of the public. They are often visible from several sides because the flags, signboards or rotors are usually provided with information on both sides. Due to the rotary motion of the rotors they may be provided with different information and/or messages on different sides, which information and/or messages are then alternately shown due to the rotary motion. The known flags, signboards and rotors moreover need relatively little maintenance and can be placed separately and independently.

A drawback of the known signboards, flags banners or rotors is that the information on them is static and does not change in colour and composition. For changing the information and/or message for instance a flag is lowered and another flag is hoisted, or for instance a placard or (advertising) poster that is placed on or in a signboard or rotor is replaced by another placard or another poster.

A further drawback of the known signboards, flags or rotors is that they are not properly visible in twilight or in the dark, unless external illumination or an internally placed separate background illumination is used. Thus the signboards, flags or rotors become dependent on power supply as a result of which the advantage of a separate and independent placement is largely lost. Moreover, due to the external illumination the attention will partially be lost and the medium looses some of its power of communication.

It is an object of the invention to improve on this.

To that end the invention provides an assembly comprising one or more devices each comprising an information carrier and a holder for the information carrier, wherein the information carrier comprises a display for displaying changing and/or moving images and wherein the display at least partially forms a wind surface for under the influence of the wind moving at least the wind surface, wherein the device comprises control means for controlling the display.

Because each of the devices in the assembly according to the invention comprises a display, a possibility to dynamically present information in the wind surface is provided. A further advantage of the device according to the invention is that the wind surface and therewith the display, is movable under the influence of the wind, as a result of which the device and particularly the wind surface provided with the display, draws the attention of the public. The assembly according to the invention is particularly suitable to be placed in the open air.

In an embodiment the assembly comprises sound reproducing equipment for reproducing a sound or background sound belonging to the images displayed, wherein the sound reproducing equipment preferably is placed in at least one of the one or more devices. The assembly thus forms a media system for reproducing visual and/or audio-visual information.

In an embodiment the control means of the one or more devices comprise transmission and/or receiving means for connection to a network, for via the network receiving and/or transmitting data, preferably image and/or sound data.

In an embodiment the assembly comprises a data processing device, such as for instance a computer, connected to the network, for exchanging data with the individual or collective devices. Preferably the assembly comprises two or more devices and these devices are coupled via the network, so that the assembly can be used for a ‘multi-screen’ presentation of changing and/or moving images. On the one hand individual images can be repeated on the various devices. On the other hand parts of an individual image can be displayed on a number of adjacently placed devices, wherein the adjacently placed devices collectively form the full image, for instance in a manner comparable to the one of a video wall.

In an embodiment at least one of the devices comprises a sensor for perceiving the surroundings of said device and/or the motion of at least the wind surface of said device, and wherein the sensor is connected to the control means of said device for transmitting a signal from the sensor to the control means. Preferably the control means are adapted for controlling the display depending on the sensor's signal.

Preferably the sensor comprises a position sensor, velocity sensor or acceleration sensor. As a result the controlling of the display can be adapted to the position of the display and/or the velocity of motion of the display in the device.

In an embodiment the sensor is adapted for measuring a force, particularly a tensile force, exerted by the wind on the wind surface or the information carrier. Said sensor may for instance in case of too high a tensile force and therefore in case of too strong a wind send an alarm signal to the control means, so that measures can be taken to prevent damage to the device.

In a further embodiment the sensor comprises a person detection sensor for detecting persons in the vicinity of the device. In an energy-saving variety of this embodiment the control means can activate the display when persons are in the vicinity of the device and switch the display off when no persons are in the vicinity of the device.

In an embodiment wherein the assembly comprises a data processing device connected to the network, the control means are adapted for forwarding the sensor's signal or a derived quantity thereof to the data processing device. Thus the data processing device may have data regarding for instance the individual or mutual position of the displays and/or the speed of motion of the displays in the various devices at its disposal. Said data may be used by the data processing device for instance for controlling the various devices for a ‘multi-screen’ presentation of changing and/or moving images and the dynamic division of parts of a full picture over several displays.

From a further aspect the invention provides a device for use in, for instance, an assembly as described above, wherein the device comprises a receiver for receiving data for displaying on the display, wherein the receiver is connected to the control means for transmitting the data from the receiver to the control means. Preferably the receiver comprises a wireless receiver, preferably a radio receiver.

In an embodiment the information carrier is movably connected to at least a portion of the holder. Preferably the device comprises a motion sensor for detecting the motion of the information carrier with respect to the holder, wherein the motion sensor is connected to the control means for transmitting a signal from the motion sensor to the control means, and wherein the control means are adapted for controlling the display depending on the sensor's signal.

In an embodiment the information carrier is rotatably connected to the holder, and the information carrier preferably comprises a wind turbine, a windmill or a rotor. The display is placed in the wind surface of the wind turbine, windmill or rotor for displaying information, which display can thus be rotated by the wind.

Preferably the wind surface comprises one or more openings for letting air pass through in order to optimise the wind catching capacity of the wind turbine, windmill or rotor. Preferably said openings have a minimum size in order to maximise the surface for displaying visual information. In order to reduce the possibly disturbing influence of the openings said openings comprise one or more of the following characteristics:
Preferably the openings comprise one or more slots placed substantially parallel or radial with respect to the axis of rotation.
Preferably the information carrier comprises a porous surface.
Preferably the wind catching surfaces are positioned so as to be at least partially overlapping, as a result of which the opening between the surfaces is covered overlappingly at least in viewing direction, so that the wind catching surfaces guarantee an optimal view.

In an embodiment the holder comprises a first holder portion for permanent connection to a basis and a second holder portion that is movably connected to the first portion, wherein the information carrier is substantially rotation-fixedly connected to the second portion of the holder. Preferably the second holder portion is rotatably connected to the first holder portion.

In a simple embodiment the first and second holder portion are substantially cylindrical, wherein a first axis of the first holder portion is substantially parallel to and/or in line with a second axis of the second holder portion.

Preferably the information carrier comprises a rotor, preferably a savonius-type rotor, which is placed so as to be rotatable about a substantially vertical axis of rotation, wherein the rotor has a substantially S-shaped cross-section in a direction substantially perpendicular to the axis of rotation of the rotor. Preferably the wind catching surfaces or wings are covered with end plates at the top side and/or bottom side. Preferably said end plates, at least the end plate placed at the topside, are provided with light-emitting addressable surface parts. In a simple embodiment the lowermost end plate can be directly connected to a generator or dynamo for generating electric power from the rotation of the rotor as described below. Preferably the lowermost end plate is directly connected to the stator of the generator (direct drive).

In a further embodiment the first holder portion comprises a mast and the second holder portion comprises a rotatable top of the mast. Preferably the information carrier is substantially rotation-fixedly attached to the rotatable top.

In an embodiment the display is substantially level and preferably flat. Preferably the display is bendable and preferably flexible.

Preferably the display is made of an electronic fabric, preferably woven from yarn-shaped material comprising an electroforetic or electroluminescent material.

Preferably the information carrier is a flag, wherein the flag, preferably on two sides, is provided with a display. Preferably the holder comprises a flagpole and/or banner arm for the flag.

In an embodiment the information carrier is made of a flexible and/or elastic material, which material preferably at least partially surrounds the display. A display can be placed on both sides of the information carrier of flexible and/or elastic material. In an alternative embodiment the display has been placed between two layers of flexible and/or elastic material and the display is enveloped by the layers. The flexible and/or elastic information carrier can be made of a fabric (woven or non-woven), preferably a polymer fabric. Preferably the information carrier is made of a flexible shockproof and unbreakable material that has little wear or rupture.

In an embodiment the information carrier comprises at least partially an electricity conducting and preferably elastic, polymer. Said parts may for instance be used for connecting the display to the control device.

In an embodiment the display comprises an LCD, nano-LCD, electrowetting display, plasma display, electroluminescent display or an electroforetic display. Preferably the electroluminescent display comprises a series of LEDs, preferably organic LEDs, placed in columns and rows for forming a matrix display.

In an embodiment the information carrier comprises a transparent housing for the display, wherein the housing preferably comprises a sealing protective layer for protecting the display from air, water and/or water vapour.

Preferably the protective layer comprises a transparent inorganic or organic coating or cover plate, such as for instance a plate made of Perspex.

The display may furthermore be provided with a sensor transmitting a control signal to the control means, which control signal contains information about the correct functioning of the display. In case of a luminescent display said sensor may for instance be a light sensor which with its light-sensitive surface is placed near the display and facing the display.

In an embodiment the device comprises means for generating electric power from a force exerted by the wind on the wind surface, preferably means for generating electric power from the movement of at least the wind surface under the influence of the wind. Preferably the means for generating electric power from a movement of the wind surface are connectable to means for energy storage, such as for instance a battery, the display and/or control means for supplying them with electric power.

In an embodiment the wind surface is rotatably connected to the holder and the means for generating electric power comprise a rotating generator or dynamo, wherein the wind surface preferably forms a wind turbine, a windmill or a rotor.

In a further embodiment the holder comprises a first holder portion for permanent connection to a basis and a second holder portion that is rotatably connected to the first portion, wherein the wind surface is substantially rotation-fixedly connected to the second portion of the holder, and wherein the means for generating electric power comprise a rotating generator or dynamo.

In a further embodiment the information carrier is provided with a flexible wind surface, wherein the means for generating electric power are adapted for generating electric power from the wind surface blowing in the wind. Preferably the wind surface is at least partially provided with a piezoelectric foil situated in the wind surface, for generating electric power from the wind surface blowing in the wind.

In a further embodiment the wind surface is spring-mounted at the holder for performing a, substantially in wind direction, reciprocal motion, wherein the device comprises means for generating electric power from said reciprocal motion. Preferably the device comprises means for converting said reciprocal motion into a circulating motion, for instance by means of a crankshaft, wherein the means for generating electric power comprises a dynamo or generator.

In a further embodiment the holder and/or the information carrier are provided with piezoelectric elements for absorbing the tensile force exerted by the wind on the wind surface, and for converting said tensile force in electric power.

In an embodiment the assembly further comprises means for generating electric power from solar energy.

From a further aspect the invention provides a device comprising a carrier and a holder for the carrier
wherein the carrier comprises a wind surface for moving at least the wind surface under the influence of the wind,
wherein the wind surface comprises an addressable surface part situated in the surface, which surface part can be switched to a first and a second state, wherein the surface part in the first state visually differs from the surface part in the second state, and
wherein the device comprises control means for addressing the surface part, and means for generating electric power from the motion of at least the wind surface under the influence of the wind.

Because the device according to the invention comprises an addressable movable surface part that can be switched between two visually different states, a possibility is thus provided to dynamically present information in the wind surface.

In an embodiment the device further comprises means for generating electric power from a motion of the wind surface.

Electric power is necessary for addressing and/or switching. The device according to this embodiment comprises means for generating electric power from a motion of the wind surface. A possibility for the separate and independent placement of the device according to the invention is thus provided. In addition the generated electric power can also be used for illuminating the wind surface during twilight or in the dark.

In an embodiment the addressable surface part comprises an electroforetic element. Electroforetic elements are elements which can be brought in visually different states by exposing the element to an electric field. An advantage of the use of an electroforetic element is that they are highly energy-saving. Particularly in combination with means for generating electric power, an energy-saving addressable surface part is advantageous. On the one hand the means for generating electric power do not have to generate a large quantity of electric power. On the other hand a surplus of generated electric power can be used and/or stored for feeding an illumination of the wind surface during twilight or in the dark.

In an embodiment the addressable surface part comprises an electroluminescent element. The use of an electroluminescent element has the advantage that this element can emit light, resulting in said element being properly visible during twilight or in the dark. The placement of external illumination or an internally placed backlight usually is not necessary any more. In addition the electroluminescent element on the wind surface may serve as light source for the surroundings of the device according to the invention.

Preferably the electroluminescent element comprises on or more LEDs, preferably one or more organic LEDs. Using LEDs and particularly organic LEDs, such as for instance polymer LEDs, is advantageous because said electroluminescent elements combine a number of properties that may be advantageous to the device according to the invention. The advantageous properties among other things include a low use of energy, a high emission and/or luminance, a light weight, can be produced as a thin layer, optionally on a flexible and bendable material, etcetera.

In an embodiment the addressable surface part is formed in the shape of letters or logos. Said letters or logos are switchable between two visually different states, as a result of which the information formed by said letters or logos can be dynamically presented. The letters or logos may for instance be periodically switched between a visible and a substantially invisible state.

In an embodiment the wind surface comprises a series of addressable surface parts that are placed adjacently or over each other and are addressable for displaying changing and/or moving images. Preferably the series of addressable surface parts are individually addressable. As a result the options for dynamically presenting information on the device are further increased. For instance different letters or logos can be switched between a visible and a substantially invisible state for periodically showing letters or logos presenting different information.

In an embodiment the addressable surface parts form pixels of a display. Preferably the series of addressable surface parts are placed in columns and rows for forming an (active or passive) matrix display. Said embodiment therefore offers a holder for a display for showing changing images, wherein the display simultaneously is movably suspended and can be brought into motion by the wind. The changing images may for instance comprise graphic images, photographic images or film or video images. It is furthermore advantageous when the displays are adapted for showing colour images. It is moreover advantageous if the device according to the invention comprises sound reproducing equipment for reproducing sound or background noise belonging to the images displayed.

In an embodiment the device comprises a receiver for the wireless reception of information for controlling the control means. The receiver is coupled to the control means which control the addressable surface part of the wind surface in accordance with the information received. For transmitting information to the receiver use can be made of known equipment such as for instance WIFI, WIMAX, UMTS equipment.

In an embodiment the means for generating electric power are adapted for generating electric power from the wind surface, for instance of a flag or a signboard, blowing in the wind. Under the influence of the wind for instance flags or signboards may be brought into a reciprocal motion. In an embodiment the device comprises means for converting said reciprocal motion into a circulating motion, for instance by means of a crankshaft, which for instance drives a dynamo or generator for generating electric power.

In an embodiment the means for generating electric power are adapted for generating electric power from a tensile force exerted by the wind on the wind surface of for instance a flag or vane. In an embodiment the wind surface is spring mounted at the holder for performing the reciprocal motion, substantially in the wind direction. The device comprises means for converting said reciprocal motion into a circulating motion, for instance by means of a crankshaft, which for instance drives a dynamo or generator for generating electric power.

In an advantageous embodiment the attachment means are adapted for rotatably attaching at least the wind surface of the device to the holder. In an embodiment the means for generating electric power are adapted for generating electric power from a rotation of at least the wind surface of the device, such as for instance a flag, vane, signboard or rotor, with respect to the holder. The circulating motion of the wind surface provided with the addressable surface part with respect to the holder, under the influence of the wind, can be directly coupled to a dynamo or generator for generating electric power. An advantage of such an embodiment is that it can be provided with known types of DC or AC generators, which for instance can easily be integrated into the holder.

In an embodiment the wind surface is provided with means for generating electric power from a motion of the wind surface. The means for generating electric power have in this case been provided in the part of the device that comprises the wind surface and that is movably attachable to the holder. As a result this part of the device can be placed as one unity on or at the holder.

In an embodiment the wind surface is rotation-fixedly connected to the holder and the holder is provided with means for generating electric power from a motion of the holder.

In an embodiment the holder is provided with a rotatable top, wherein the rotatable top is provided with the means for generating electric power from the rotation of the top, and wherein the wind surface can be rotation-fixedly coupled to the top.

In an embodiment the device also comprises means for generating electric power from solar energy, such as for instance solar cells. Said combination has the advantage of extra and other means being available for generating electric power, as a result of which also in times of calm weather energy can be generated. As a result the device according to the invention becomes more reliable because in periods of calm weather as well energy can be generated. In addition more energy is available for the device according to the invention and the energy use of this device can increase. The solar cells may for instance be disposed on the wind surface and/or on the holder. In an embodiment transparent and/or flexible solar cells have been disposed on the wind surface. In an embodiment they comprise deye solar cells.

In an embodiment the means for generating electric power from a motion of the wind surface can be coupled to the addressable surface part and/or the control means for supplying them with electric power.

In an embodiment means are provided for at least temporarily storing the generated electric power, such as for instance a rechargeable battery, a fuel cell or capacitor. As a result the device according to this embodiment is capable of bridging periods in which little or no energy is generated. For bridging such periods the device according to the invention can also be connected to an external energy source, for instance the electricity grid. The means for at last temporarily storing the generated electric power may also serve as power supply for other, possibly external equipment.

In an embodiment the wind surface is flexible. This results in a further advantageous dynamic effect as known from flags.

In an embodiment the device comprises a flag provided with the wind surface.

Preferably the flag is provided with one or more addressable surface parts on two sides.

Preferably the holder comprises a flagpole and/or banner arm.

Preferably the wind surface is made of yarn-shaped material, preferably the wind surface comprises a woven material.

Preferably the yarn-shaped material is switchable to a first and a second state, wherein the surface part in the first state visually differs from the surface part in the second state. Preferably the yarn-shaped material comprises an electroforetic or an electroluminescent material.

In an embodiment the device comprises a rotor provided with the wind surface. Preferably the rotor is placed so a to be rotatable about a substantially vertical axis. Preferably the rotor has a substantially S-shaped cross-section in a direction substantially perpendicular to the axis of rotation of the rotor.

Preferably the rotor is provided with one or more addressable surface parts on two sides.

Preferably the rotor is provided with a substantially vertically extending opening.

Preferably the device comprises means for synchronising the rotation of the rotor with the controlling of the one or more addressable surface parts.

In an embodiment the device comprises a signboard or a vane provided with the wind surface.

The invention further provides a flag, rotor, signboard or vane suitable and intended for a device as described above.

The invention further provides the suspension of a flag which on one or both sides is provided with a matrix display for displaying changing and/or moving images.

In an embodiment the matrix display is flexible.

In an embodiment the matrix display is built up from electroforetic and/or electroluminescent elements. Preferably the electroluminescent elements comprise LEDs, preferably organic LEDs.

In an embodiment the flag is provided with means for generating electric power from solar or wind energy.

The invention further provides a rotor for rotary placement on a holder and provided with a wind surface for driving a rotation of the rotor, wherein the wind surface is provided with addressable electroforetic and/or electroluminescent elements. Preferably the electroluminescent elements comprise LEDs, preferably organic LEDs.

In an embodiment the electroforetic and/or electroluminescent elements are adapted for forming letters, logos or a matrix display.

In an embodiment the addressable electroforetic and/or electroluminescent elements are fed by the electric power generated by the rotor.

In an embodiment the rotor has a substantially S-shaped cross-section in a direction substantially perpendicular to the axis of rotation of the rotor.

Preferably the rotor is provided with addressable electroforetic and/or electroluminescent elements on two sides for displaying changing and/or moving images.

In an embodiment the rotor is further provided with means for generating electric power from solar and/or wind energy.

The invention will be further elucidated on the basis of the exemplary embodiment shown in the attached drawings, in which:

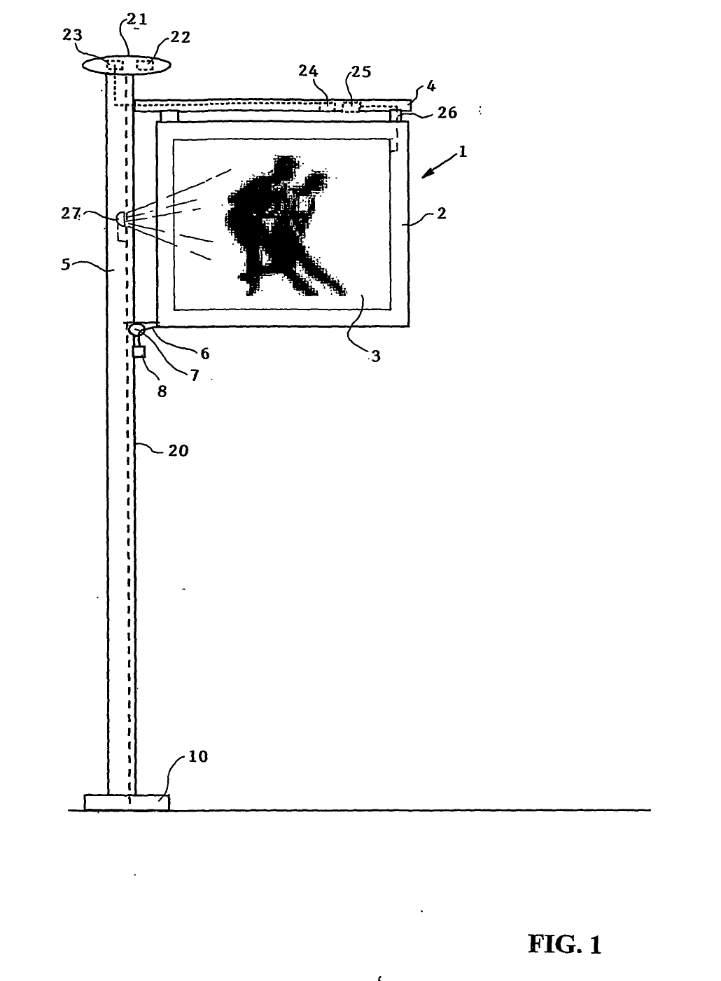

FIG. 1 shows a schematic view of a first exemplary embodiment of a device according to the invention;

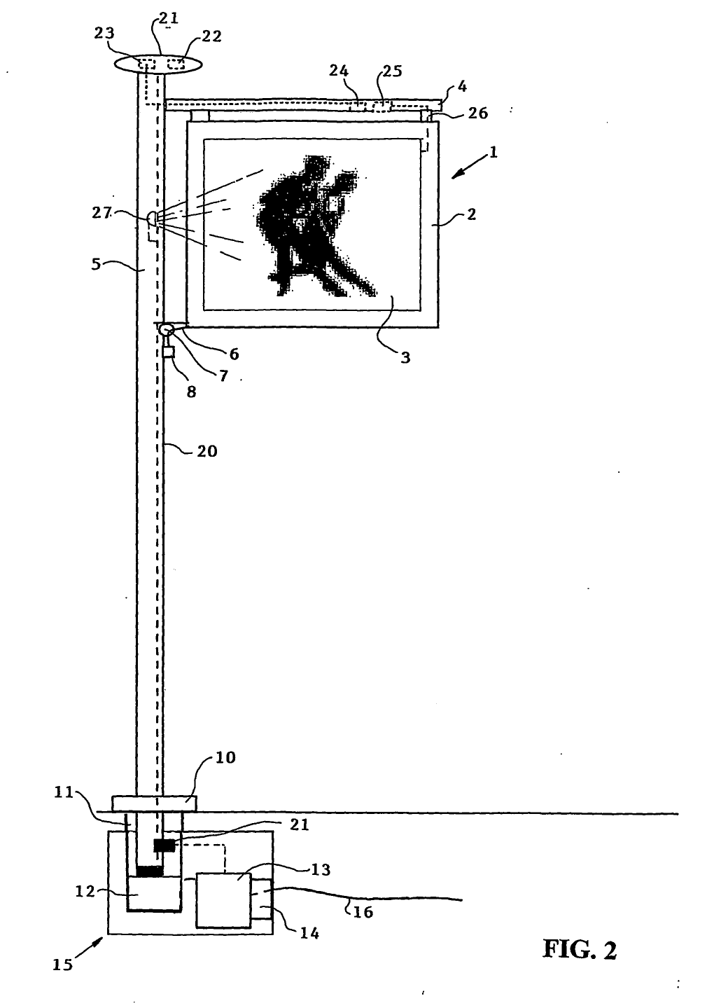

FIG. 2 shows a schematic view of a second exemplary embodiment of a device according to the invention;

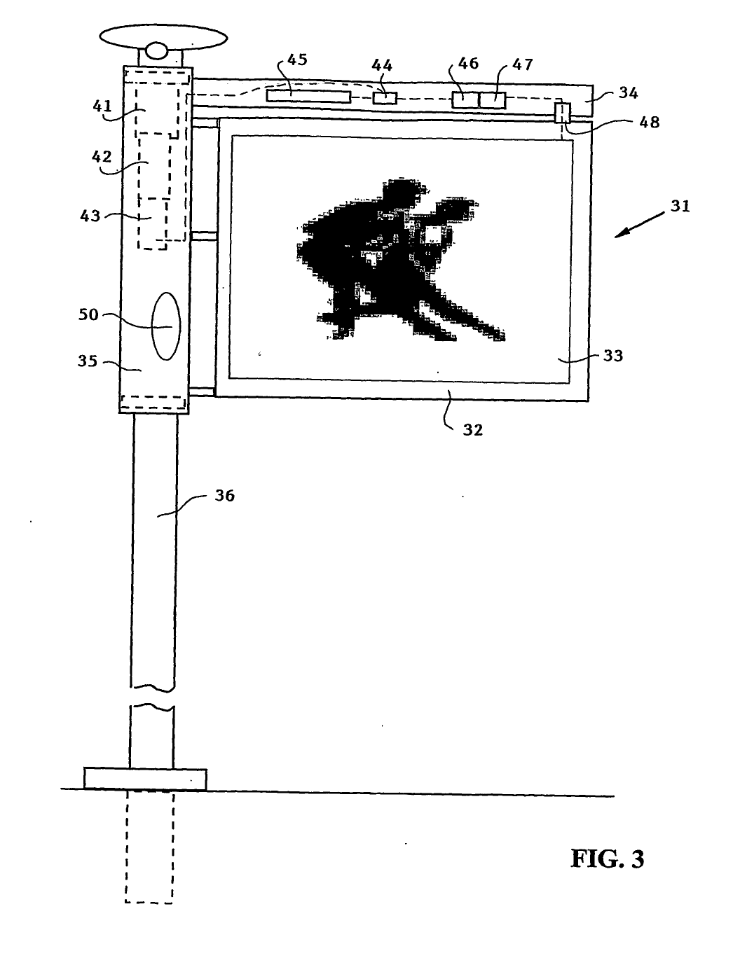

FIG. 3 shows a schematic view of a third exemplary embodiment of a device according to the invention;

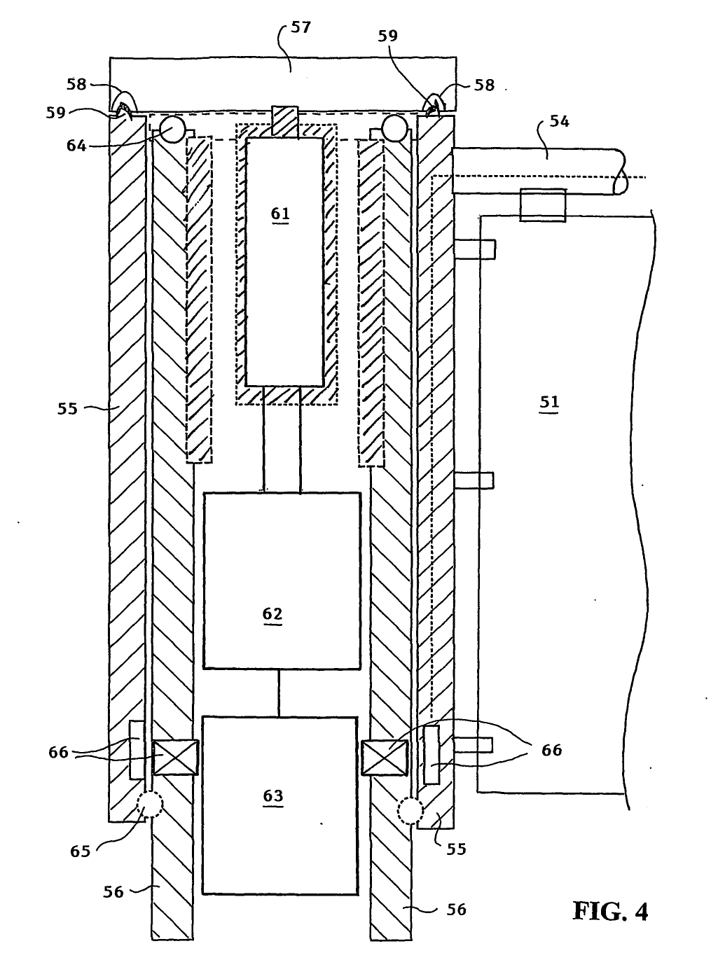

FIG. 4 shows a schematic view in cross-section of a part of a fourth exemplary embodiment of a device according to the invention;

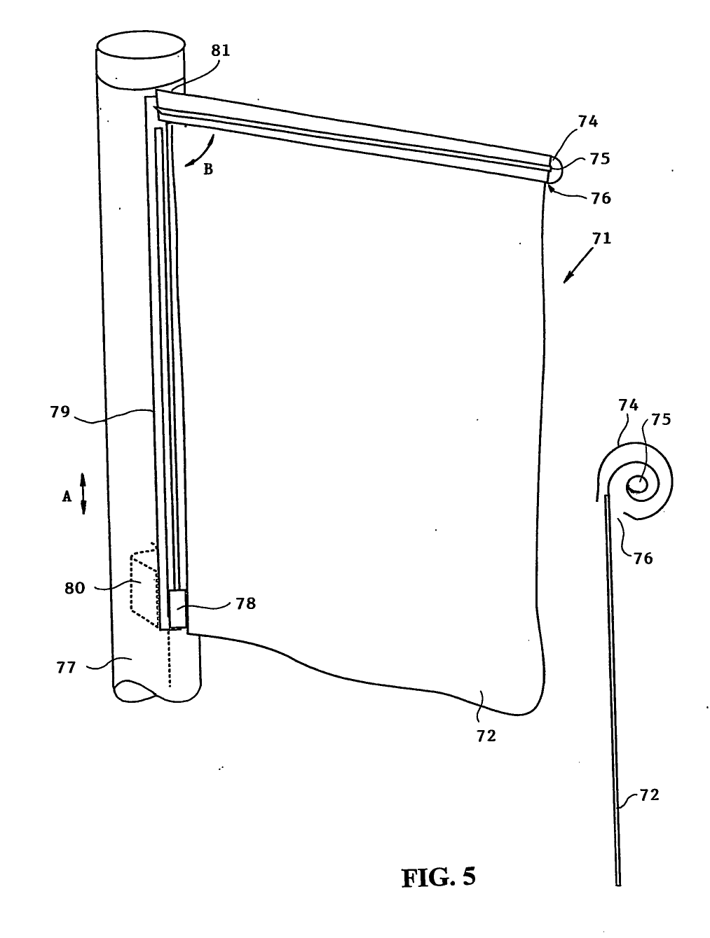

FIG. 5 shows a schematic view of a fifth exemplary embodiment of a device according to the invention;

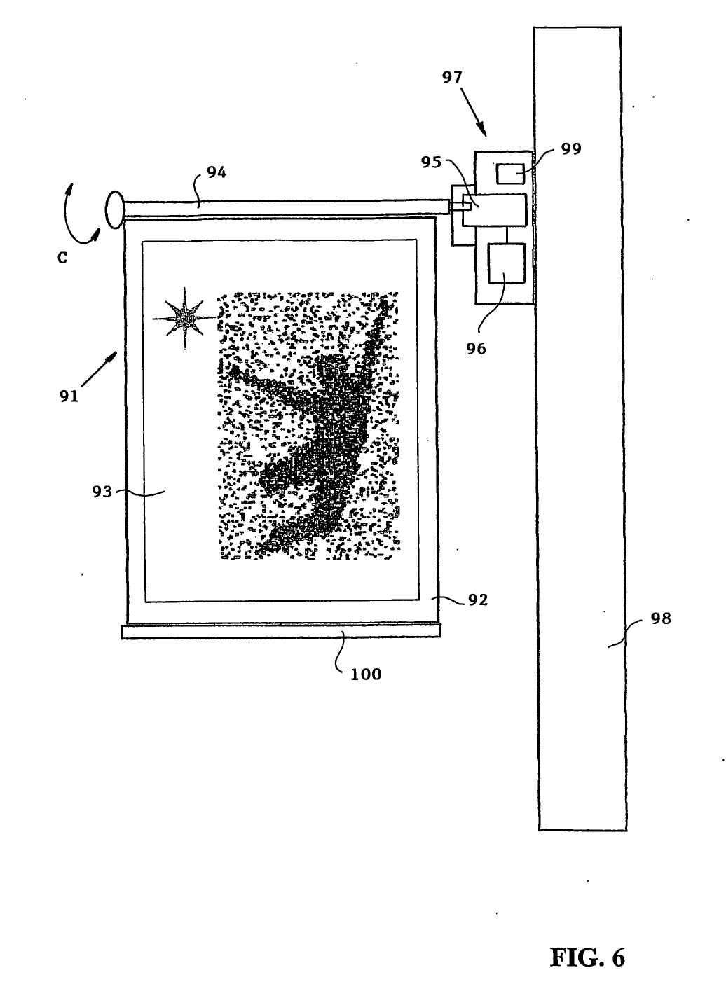

FIG. 6 shows a schematic view of a sixth exemplary embodiment of a device according to the invention;

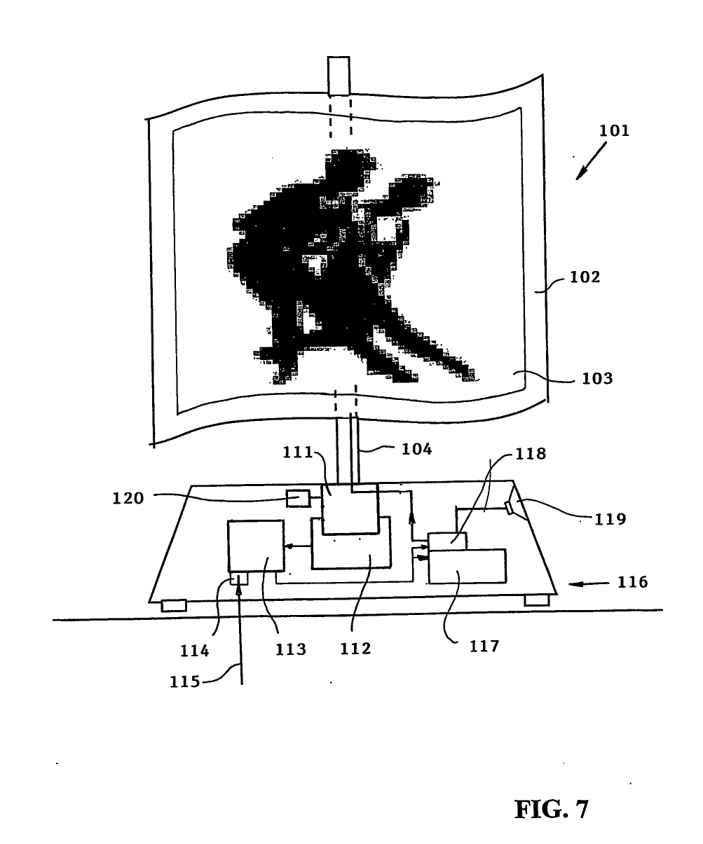

FIG. 7 shows a schematic view of a seventh exemplary embodiment of a device according to the invention;

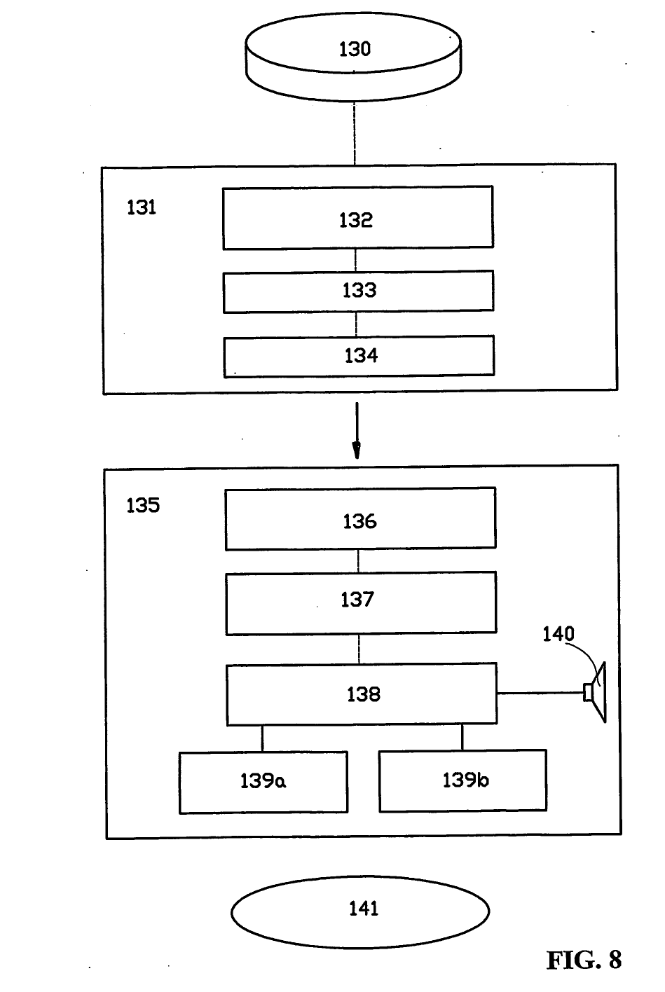

FIG. 8 shows a schematic diagram of the operation of a device according to the invention;

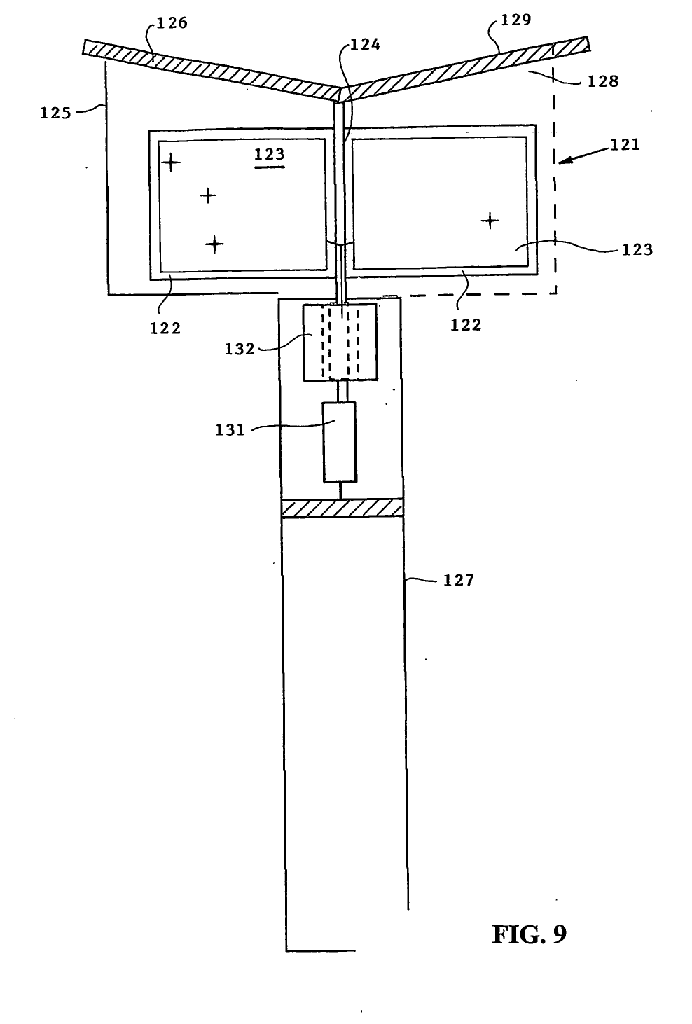

FIG. 9 shows a schematic view of an eighth exemplary embodiment of a device according to the invention;

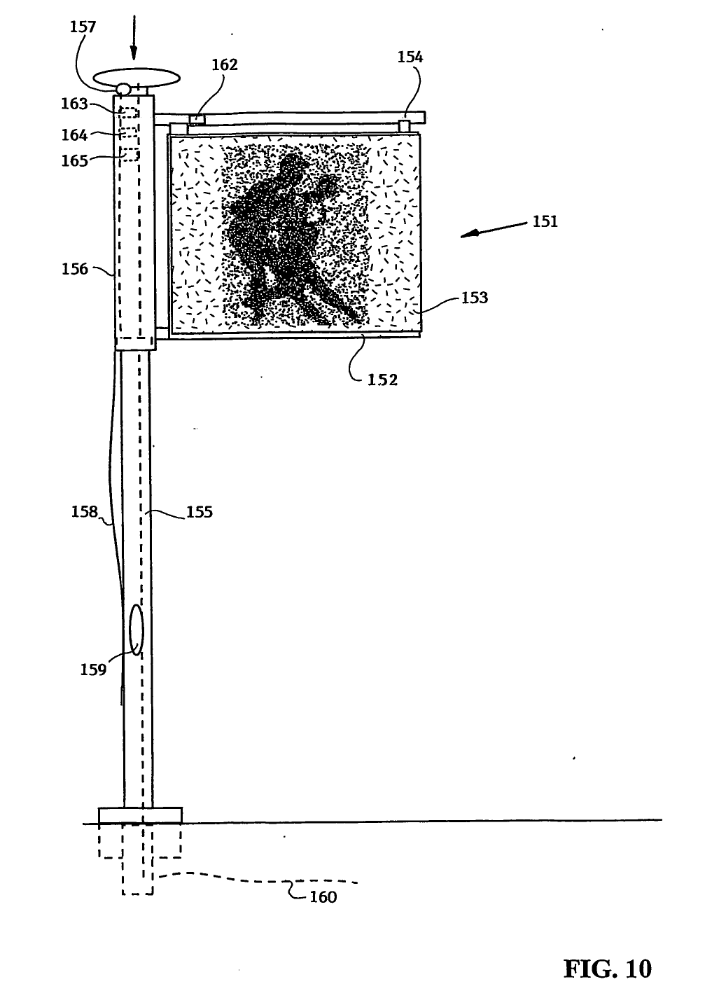

FIG. 10 shows a schematic view of a flag according to the invention suspended from a flagpole (banner pole); and

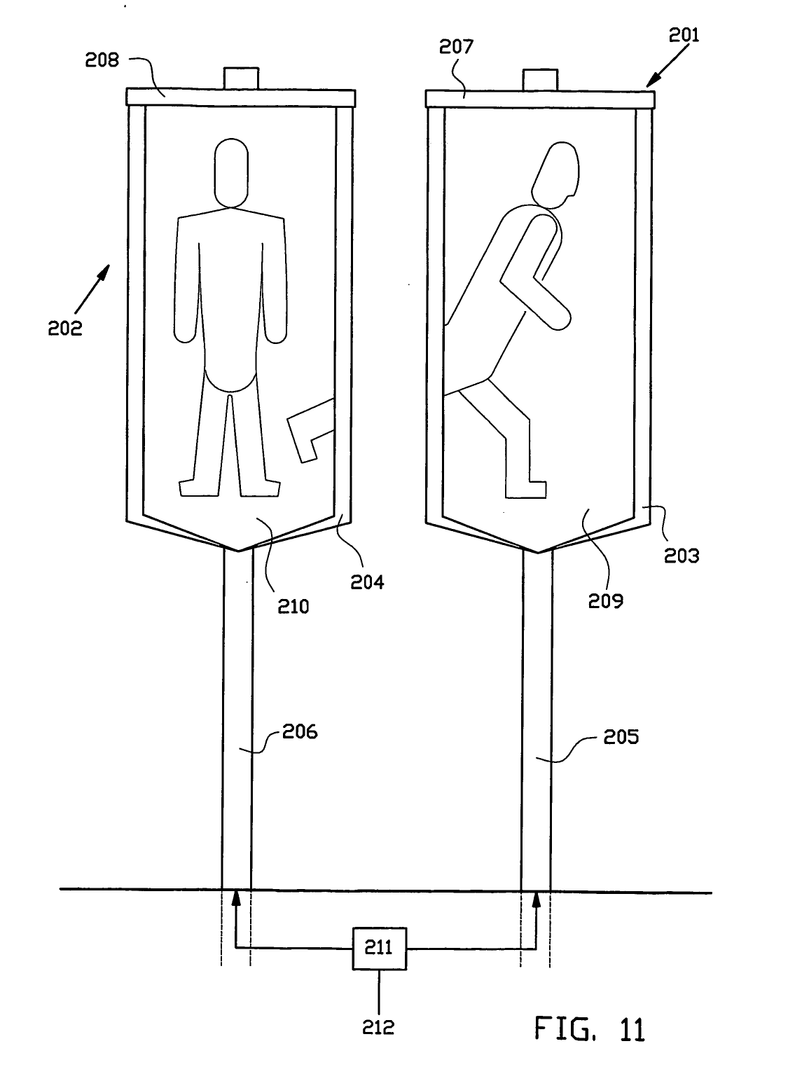

FIG. 11 shows a schematic view of an assembly according to the invention.

A first exemplary embodiment of the device according to the invention is shown in FIG. 1. FIG. 1 shows a flag or banner 1 provided with a wind surface 2 which on both sides is provided with a matrix display 3. The flag 1 is suspended from a practically horizontally placed banner arm 4. Said banner arm 4 is attached to the flagpole 5 by means of a rotary joint which transmits the image signal to the display. The flag or banner 1 can be made of a rigid material. Preferably, however, the flag or banner 1 is made of a flexible material and it is provided with a flexible display 3. Preferably the flag or banner 1 is also attached to the flagpole 5 with its bottom side, for instance by means of a halyard 6 which runs over a pulley 7 and at its end is provided with a counter weight 8 for keeping the flag or banner 1 taut. The flag 1 is rotation-fixedly attached to the flagpole 5 via the banner arm 4 and the pulley 7. Said flagpole 5 is rotation-fixedly placed on a rotatable mast footing 10, which is permanently anchored in the ground.

The display 3 in this case is for instance of the electroforetic type. The image elements of such a screen comprise a large number of spherical micro cells placed adjacently in a surface, the micro cells being provided with two types of particles that contrast in colour or tone. Said two types of particles are provided with an opposite electrical charge. By applying an electric field it is ensured that one of said two types of particles surfaces. By dividing the display 3 into a matrix of rows and columns of individual pixels provided with means for applying a desired electric field near each pixel, a contrastful image can be built that is properly visible from almost all viewing angles. Preferably the control takes place by means of an active matrix control. The display 3 is fed via an electrical cable 20 placed in the flagpole 5, which cable is connected to the electricity grid and/or a battery (not shown). The electrical cable 20 passes electric power from the mast anchoring 10 to the mast top 21. Said mast top 21 is provided with a transmitter/receiver 23. Via the transmitter/receiver 23 the device can be provided with the images to be displayed and instructions for the control device 24 in a wireless manner. To that end the control device 24 can be connected to a network (not shown) via the transmitter/receiver 23. The receiver is fed via the electrical cable 20. The transmitter/receiver 23 is connected to a control device 24 which may for instance be placed in the banner arm 4. The control device 24 ensures the correct control of the displays 3 on both sides of the wind surface 2. The control device 24 for instance comprises a processor, a working memory, a storage medium, such as for instance a hard disk, and a decompressor. The control means 24 are connected to both displays 3 on both sides of the wind surface 2 by means of a splitter 25. In this exemplary embodiment the control means and/or splitter are placed in the banner arm 4 through which a signal cable 26 has been drawn for connection of the displays 3. In an alternative embodiment the control means 24 and/or the splitter 25 can be placed in the mast 5, preferably near the mast top 21.

Because the electroforetic display 3 itself cannot emit light, the flagpole 5 near the flag 1 is provided with illumination means 27 which are connected to the electrical cable 20. The illumination means 27 are adapted for illuminating the display 3 during twilight or in the dark of the night. The degree of ambient light can be measured with the sensor 22.

The exemplary embodiment as shown in FIG. 1 shows a flagpole 5 at which one or several flags 1 can be placed, which flags 1 can be hoisted and optionally lowered, either electrically driven or not, preferably via the mast 5. The flag 1 that is suspended from this flagpole 5 comprises a lightweight, preferably flexible matrix display 3 for showing changing images, preferably changeable (photo)graphic images or dynamic and colourful film or video images. The device is provided with means 23 for wireless and remote control of the device. With respect to the conventional flags in conventional flagpoles such an installation has the advantage of the images on the flag being capable of being refreshed or changed by remote control, without the flag having to be lowered and another flag having to be arranged in the mast. This is advantageous for instance at locations where flag installations regularly have to be provided with a flag having another pattern, such as embassies, hotels or conventions areas.

Such a flagpole 5 is equipped with electricity facilities and a control installation 24 for the displays 3 with which images can be shown on the displays 3. As a result it is possible to show information to passers-by alternately and continuously.

In comparison with a traditional display device such an installation has the advantage that the display 3 can be attached at a high level above the ground as a result of which it is less sensitive to theft. Another advantage in comparison with a conventional display device is that the display that moves along in the wind gives an additional visual effect, which is striking to passers-by. Moreover the images and the senders of those images shown on the displays 3 can derive status and allure usually associated with the use of flags.

Flags 1 provided with displays 3 on both sides moreover have the advantage of being able to show a richer (photo)graphic image than the current generation of flags, which are provided with printed graphic patterns or pieces of sown-together bunting of varying colours. In addition the flags 1 according to the invention have the advantage that they are able to show dynamic and moving images, for instance animations, (digital) video recordings or digitised film recordings.

The electroforetic displays used here have the advantage that they are able to retain a certain image, that means showing it permanently, using a minimum of electric power. As a result the electroforetic display is highly economical in electricity use. If the user of the installation wishes to place another image on the display 3 the various pixels of the display 3 are controlled for applying an electric field as a result of which the new image appears on the display 3. After placing said new image, the power supply to the display 3 can be virtually stopped, so that no electric power is wasted.

The display 3 can also be of the electroluminescent type. Because an electroluminescent display emits light itself, this variety does not need the illumination 27 for the display 3.

The display 3 can also be made of an electronic fabric, wherein the display 3 is manufactured of a woven yarn-shaped material that comprises an electroforetic, electroluminescent or otherwise colour-changing material. Such a display 3, which then also forms the wind surface 2, has the advantage that the material of the display 3 partially lets air through and moves beautifully in the wind.

The displays 3 described above are furthermore provided with a wind and water repellent and sealing coating, which may also be dirt repellent. This offers the advantage that wind and water have no disturbing influence on the display and/or the images shown thereon. Such a coating can also protect the display from external influences such as dirt, dust, moisture, or others, which may lead to a reduced visibility or luminescence. At the edges the displays 3 can optionally be provided with an enveloping, gas-filled layer, such as for instance a cushion or tube giving the flag extra protection against wind, water and bumping.

Via a connecting cable that has been passed through the mast 20, the control device 24 can also be connected to a network, as a result of which the device as shown in FIG. 1 can be included in an assembly of devices as described below.

In a second embodiment as shown in FIG. 2, the flagpole 5 is connected via a transmission 11 to a generator 12 which is placed in the ground anchoring 15 of the flagpole 5. When the wind direction changes, the flag 1 will be forced to rotate in the new wind direction. Because the flag 1 is rotation-fixedly coupled to the flagpole 5 the flagpole 5 will as a result rotate over a certain angle. The rotation of the flagpole 5 is transferred via the transmission 11 to the generator 12 which is thus driven for generating electric power.

The generated power of the generator 12 is supplied to a battery or capacitor 13 where the electric power is stored for future use. In this exemplary embodiment the battery 13 is also connected to a battery charger 14 which is coupled to the electricity grid via a feeder cable 16.

The generator 12 preferably is provided with a sensor for determining the direction in which the flag points. This position information can be sent to the control means and/or, in case the device is part of an assembly controlled via a central computer, to the central computer.

FIG. 3 shows a third exemplary embodiment of the device according to the invention. This exemplary embodiment also shows a flag or banner 31 provided with a wind surface 32 which on both sides is provided with a display 33. This has the advantage that the display 33 has a wider range as a communication medium and can be seen by passers-by from several sides at a time.

Preferably the flag 31 and the displays 33 placed thereon are made of a flexible and/or bendable material. This has the advantage that the display 33 is able to move under the influence of the wind wherein the wind surface 32 and thus the surface of the display 33 as well changes shape. This moving or blowing in the wind results in a visually attractive sight that draws the attention of the passers-by. The flag 31 is rotation-fixedly connected to a rotary tube 35 provided with a banner arm 34 attached thereto. Said rotary tube 35 can be disposed around a known flagpole 36. And by means of a known hoisting device can either be hoisted or lowered, either electrically driven or not, along the mast 36. The rotary tube 35 is able to rotate freely about the flagpole 36. The rotary tube 35 is provided with a generator 42 which by means of a transmission 41 is coupled to the flagpole 36. When the rotary tube 35 rotates about the flagpole 36, the generator 42 is driven via the transmission 41 for generating electric power. Said electric power is stored in a battery 43. The battery 43 serves as power supply for the electronic components of the device, such as:
a receiver 44 for the radiographic reception (for instance WIFI or similar) of image information and/or control commands, wherein the receiver 44 is provided with an antenna 45 for receiving the signal;
control means 46 provided with means for decompressing the received signal from the receiver 44 and controlling the displays 33 on both sides of the wind surface 32;
a splitter 47 for doubling and optionally mirroring the image information for controlling both displays 33.

In said third exemplary embodiment said electronic components have been placed in the banner arm 34 and connected to both displays 33 on both sides of the wind surface 32 of the flag 31 by means of a signal cable 48 running through the suspension of the flag 31. The rotary tube 35 is also provided with one or more speakers 50 for reproducing an audio signal belonging to the images shown on the displays 33 or for reproducing background noise. The sound to be reproduced via the speaker 50 may be received by the receiver 44 together with the image information via an audio-visual signal.

An advantage of such a device as shown in FIG. 3 is that it can be placed at the known flagpoles 36 as one unity without particular adaptations to the flagpoles 36 being necessary. Furthermore such a device has the advantage that due to free rotation it is less sensitive to damage caused by high wind pressure or other weather conditions.

The flag 31 can also make a flying motion as a result of the wind. This flying motion of the flag 31 is transferred via the rotation-fixed coupling with the banner arm 34, and results in a reciprocal motion (over a small angle rotation) of the banner arm 34. By coupling the banner arm 34 to the transmission 41 this motion is capable of driving the generator 42. For instance the transmission 41 is adapted for converting the reciprocal motion of the banner arm 34 into a circulating motion for driving the generator 42. In this way the generator 42 is capable of generating electric power from the flag 31 blowing in the wind.

FIG. 4 shows a view in cross-section of a fourth exemplary embodiment of a device according to the invention. The exemplary embodiment according to FIG. 4 is comparable to the exemplary embodiment as shown in FIG. 3, that means that the flag 51, which is provided with a display on both sides, is rotation-fixedly suspended from a rotary tube 55 which is provided with a banner arm 54. The flag 51 is suspended from the banner arm 54 as a result of which the display is hung out at all times and the image remains optimally visible despite the motion under the influence of the wind. The rotary tube 55 can be placed around the flagpole 56 and can be hoisted and lowered, either electrically driven or not, along said flagpole 56. In the exemplary embodiment of FIG. 4, just like in the exemplary embodiment of FIG. 3, the electronic components have been placed in the banner arm 54. However, contrary to the exemplary embodiment of FIG. 3, the means for generating electric power from the rotation of the flag 51 have been placed in the flagpole 56. To that end the flagpole 56 has been provided with a rotatably placed mast top 57 which via a transmission 61 is coupled to a generator 62 that has rotation-fixedly been placed in the flagpole 56. A rotation of the mast top 57 thus drives the generator 62 for generating electric power. Said electric power generated is supplied to a battery 63 which has also been placed in the flagpole 56. The mast top 57 can be coupled with the rotary tube 55. To that end the bottom side of the mast top 57 is for instance provided with recesses 58 into which attachment pins 59 protruding from the upper distal end of the rotary tube 55, can be accommodated. As a result the rotary tube 55, if hoisted to the top of the flagpole 56, is coupled to the mast top 57. By rotation of the rotary tube 55 under the influence of the wind, as described above, said rotation will be transferred to the mast top 57 for driving the generator 62 for generating electric power. For reducing frictional losses the mast top 57 is connected to the flagpole 56 via a bearing 64 (for instance a thrust bearing). In addition the rotary tube 55 can also be provided with a bearing 65 so that the rotary tube 55 as well can rotate easily about the flagpole 56. The generated electric power that has been stored in the battery 63 may for instance be transferred from the flagpole 56 to the rotary tube 55 by means of a wiper contact or inductive transfer means for feeding the electronic components in the banner arm 54 and the displays on the flag 51.

FIG. 5 shows a further development of the exemplary embodiments as shown in the FIGS. 1, 2, 3 and 4. If namely use is made of a flexible and/or bendable wind surface 72 that has been provided with a display on both sides then the wind surface 72 according to this further development can be rolled up, particularly about a centre axis 75 which is placed in the banner arm 74 so as to be rotatable. At a side facing down, the banner arm 74 is provided with an opening through which the wind surface 72 can be accommodated in the banner arm 74. At the lower side the wind surface 72 is connected with the flagpole or the rotary tube 77 via the suspension 78 which can be moved in vertical direction (in the direction of arrow A) in a guide 79 along the mast or rotary tube 77. In the exemplary embodiment the guide 78 is coupled to a climbing motor 80 for having the suspension 78 move along the guide 79. In case of a rolled out wind surface 72, said climbing motor 80 may ensure the necessary tension of the wind surface 72 along the flagpole or rotary tube 77 as a result of which the display is at all times suspended and the image remains optimally visible. In this further development the banner arm 74 is furthermore hinged to the flagpole or rotary tube 77 by means of hinge 81. As a result the banner arm 74, preferably when the wind surface 72 is fully accommodated in the banner arm 74, can be folded down (in the direction of arrow B) as a result of which the banner arm can be placed parallel to and along the flagpole or rotary tube 77. In a further development the banner arm 74 can also be accommodated in the flagpole or rotary tube 77. An advantage of this exemplary embodiment is that it offers storage options for storing the flag provided with displays, for instance for protecting the flag in case of bad weather (for instance very hard wind or hailstorms).

FIG. 6 shows an exemplary embodiment of a signboard according to the invention. The signboard 91 comprises an inflexible or rigid wind surface 92 which is provided with a display 93 on both sides. The signboard 91 is rotatably suspended from a banner arm 94 such that the signboard 91 is rotatable (in the direction of arrow C) about the axis of the banner arm 94. The banner arm 94 is coupled to a generator 95 that converts a reciprocal swivel motion of the signboard 91 into electric power. Said electric power is supplied to a battery 96. The generator 95 and the battery 96 have been placed in a footing 97 for the banner arm 94. Said footing may for instance be placed at a facade or, as shown in FIG. 6, at a mast (for instance a flagpole) 98. The electronic components for controlling the displays 93 on both sides of the signboard 91 have also been placed in said footing 97, and are connected to the battery 96 which serves as supply source for said electronics 99. The electronics 99 can be fully or partially accommodated in the banner arm 94 as shown in the FIG. 1, 2 or 3.

In a further development, the signboard 91 can be made of a flexible and/or bendable material. Preferably the signboard is then provided with means for stretching the wind surface 92. This stretching can take place by means of a suspension weight 100 or for instance by means of a device for stretching a cloth as known from for instance buckling arm screens in awnings. The use of a flexible wind surface 92 has the advantage that this wind surface can be rolled up in the banner arm 94 similar to the device as shown in FIG. 5, as a result of which the signboard can be protected from undesirable weather influences.

FIG. 7 shows a further exemplary embodiment of a device according to the invention. The device comprises a rotor 101 provided with a wind surface for the wind 102 which is attached around an axis of rotation 104. The rotor 101 of this exemplary embodiment has a substantially S-shaped cross-section in a direction substantially perpendicular to the axis of rotation 104. The wind surface 102 is provided with a display 103 both at the front and at the rear, which displays preferably are placed such that they substantially follow the aerodynamic shape of the wind surface 102. Under the influence of the wind the rotor 101 will start rotating about its axis 104, as a result of which the images shown on the displays 103 on both sides of the rotor 101, are rotated and can be seen over an angle of 360 degrees around the device. It may be advantageous here to provide the device with a brake for decelerating too fast a rotation of the display 103, so that the display 103 can also be viewed by passers-by in case of high windspeeds.

The axis 104 is coupled to a transmission 111, optionally provided with a deceleration, for driving a generator 112 for generating electric power from the rotation of the rotor 101. The generated electric power can be stored in a rechargeable battery 113 which by means of a charging device 114 is connected to the electricity grid. As a result the battery 113 can both be charged by means of the electric power generated by the generator 112 and by the electric power from the electricity grid via the connection cable 115. The transmission 111, generator 112 and battery 113 have been placed in a footing 116 in which further storage means 117 have been disposed for storing image data that can be shown on the displays 103. Examples of such storage devices 117 are a video player, CD player, DVD player and/or a computer memory (in the form of memory chips or a hard disk). The control device 118 (for instance in the form of a computer or PC) controls the display 103 for showing the image information stored in the memory means 117. In addition the footing 116 is provided with one or more speakers 119 for reproducing an audio signal belonging to the images shown on the displays 103.

Instead of the storage device 117, the control device 118 (for instance in the form of a computer), either wireless or not, can be connected to the internet from where the control device 118 is able to receive audio-visual data and control data about the IP protocol. In case of a wireless connection between the control device 118 and the internet (or an otherwise known transmitter such as a WIFI transmitter, UMTS, WIMAX) an antenna and receiver can be placed in the axis of rotation 104 or be accommodated in the rotor 101.

In a further development the transmission 111 is coupled to a position sensor or speedometer 120. The signal of the position sensor or speedometer can be supplied to the control device 118. In this way it is possible to synchronise the images shown by the displays 103 with the rotation of the display 103 about the axis of rotation 104. In combination with suitable software for the control of the image material on the display 103 a moving image can thus be visualised on a rotating display that gives the illusion that the display shows a three-dimensional image. For instance an image of an upright figure is seen at a front of the device as the front of this figure, whereas the same figure at a side or the rear of the display at the same moment can be seen as the corresponding side and rear of the upright figure.

FIG. 8 shows a schematic view of the operation of an exemplary embodiment of the device according to the invention. The images and/or information that have to be shown on the device according to the invention have for instance been stored in an image database 130. Examples of such an image database are video players, CD players, DVD players, computer memories, files on the internet, etcetera. An audio-visual server 131 is able to download the desired image information from the image database 130, optionally via the internet via an IP protocol, and if necessary, process the image as desired by means of the image-processing device 132. After that the audio-visual server 131 can convert the image information so that it can be shown on the displays of the device. Said conversion takes place using the display controller 133. Then this information, that may or may not be encrypted or compressed, is forwarded to a transmitter 134 in order to transmit the data to the device 135. Preferably a so-called WIFI transmitter, WIMAX or DMBv is used. The transmission of the data from the audio-visual server 131 to the device 135 can also take place via a satellite connection or cable connection, or via the internet.

The data as sent by the transmitter 134 are received by the device according to the invention 135 by a receiver 136. The data received are subsequently decrypted and/or decompressed in a processing device 137. Subsequently this signal is supplied to a splitter 138 which splits the signals for the various displays 139a, 139b and the audio signal for the speaker 140, for presenting audio-visual data originating from the image database to a viewer 141.

The splitter 138 may further be provided with means for, if necessary, adjusting the image to be shown so that the image which is shown on the display 139a at the one side of the device 135 is mirrored with respect to the image shown on the display 139b at the other side of the device 135. As a result for instance flags such as the American flag can be correctly shown on both sides of the device, namely with the field of stars near the flagpole.

FIG. 9 shows a further exemplary embodiment of a device according to the invention for illuminating the surroundings of the device. Said exemplary embodiment shows a rotor 121 provided with one or more wind surfaces 122 that have been placed around an axis 124. The rotor 121 is rotatably placed in a housing 125 which at its topside is closed by means of a roof structure 126. The wind surfaces 122 have been provided with electroluminescent surfaces 123 for illuminating the immediate surroundings of the device according to the invention. With its axis of rotation 124, the rotor 121 is rotation-fixedly connected to a generator 132 which is coupled to the mast 127 via a transmission 131. Under the influence of wind the rotor 121 will rotate for driving the generator 132 for generating electric power. This electric power can be stored in for instance a rechargeable battery that has been placed in the axis 124 or in the wind surface 122. Said energy serves as power supply for the electroluminescent surfaces 123.

If illumination is desired, for instance in the evening or at night, the electroluminescent surfaces are switched on for emitting light. In an embodiment the rotor 121 is stopped, for instance using a brake device engaging onto the axis 124, for counteracting possibly hindering fluctuations of the illumination of the surroundings due to rotation of the electroluminescent surfaces 123.

Preferably the inside of the roof structure 126 is provided with a mirroring surface 128 that reflects the light emitted upwards downwards, that means to the footing of the mast 127. Moreover the electroluminescent surfaces 123 can be provided with optical means (such as for instance a prism or lens array) in order to sent the light emitted by the electroluminescent surfaces 123 to the desired locations in the surroundings of the device. Such a device can for instance be used as exterior lighting in parks or gardens. It will be clear that the housing 125 is fully or partially transparent for letting through the light emitted by the electroluminescent surfaces to the desired locations in the surroundings of the device and is fully or partially provided with openings for letting in wind for driving the rotor 121. Preferably the part of the housing 125 around the rotor 121 and at the lower side of the rotor 121 is provided with openings as shown at the right-hand side of the housing in FIG. 9.

In a further development the roof structure 126 is provided with solar cells at the upper side 129 for generating electric power from sunlight for during the day charging the rechargeable battery for feeding the electroluminescent surfaces 123.

FIG. 10 shows a comparable embodiment as shown in FIG. 4. That means the device as shown in FIG. 10 comprises a flag 151 comprising a wind surface 152 which on both sides is provided with a display 153 for showing changing and/or moving images. At an upper side the flag 151 is attached to a banner arm 154 and at the side facing the flagpole, to a rotary tube 156. The banner arm 154 is also connected to the rotary tube 156 so that the unity of the rotary tube 156, the banner arm 154 and the flag 151 can be hoisted and lowered as one unity along the flagpole 155 by means of the hoisting cable 158 running over a pulley 157 placed in the mast top.

The rotary tube 156 is furthermore provided with the receiver 163, the control/decompression means 164 and the splitter 165 for receiving and processing audio-visual signals and the control of the displays 153 and for instance a speaker 159, which in this example has been placed at the bottom in the flagpole 155.

Contrary to the exemplary embodiment of FIG. 4 the device of FIG. 10 is placed in a known flagpole 155, that means without a generator. The device is externally fed via a feeder cable 160 which for instance is connected to the electricity grid.

In a further exemplary embodiment as shown in FIG. 11, two devices 201, 202 have been placed adjacently, wherein each device 201, 202 comprises an information carrier 203, 204 and a holder 205, 206 for the information carrier 203, 204. The holders 205, 206 are masts provided with a banner arm 207, 208 from which the information carriers 203, 204 have been suspended. The information carriers 203, 204 have been provided with a display 209, 210 for reproducing images, in this embodiment the information carriers 203, 204 have been provided with flexible matrix displays 209, 210 for showing changing images, preferably changeable (photo)graphic images or dynamic and colourful film or video images. In principle each exemplary embodiment described above can be used for the devices 201, 202.

The devices 201, 202 have each been connected to a central computer 211 for controlling the individual devices 201, 202. Via a line 212 the central computer 211 is connected to a data network for optionally exchanging data with a further remote computer (not shown).

Because the devices 201, 202 are included all in one assembly and are controlled by means of a central computer 211, an overall picture can be dynamically divided into parts of the overall picture, which parts are shown on the various devices 201, 202. To a viewer, the several (in this case two) independently moving displays 209, 210 give the impression of forming one large display, as schematically shown in FIG. 11.

Finally it is noted that the exemplary embodiments of the invention described above are meant to be an illustration of the invention and not a limitation of the invention. An expert will certainly be capable of designing alternative embodiments that fall within the scope of protection of the attached claims.

For instance the specific placement of the parts in one of the exemplary embodiments described above can also be used in alternative embodiments of the other exemplary embodiments described above.

For instance the device may also be provided with a wind sensor which, from the rotation or the speed of movement, acceleration or turning point of the display, measures what wind strength and rotation speed may occur at any given moment in order to regulate the image control and/or light intensity and alternate the image surface from the one state to the other state.

For instance the display and the wind surface may be formed as one unity.

1-50. (canceled)

51. Assembly comprising one or more devices each comprising an information carrier and a holder for the information carrier, wherein the information carrier is movably connected to at least a portion of the holder,
wherein the information carrier comprises a wind surface for moving at least the wind surface under the influence of the wind,
wherein the wind surface comprises a display comprising a series of addressable surface parts situated in the surface, which surface parts can be switched to a first and a second state, wherein the surface parts in the first state visually differs from the surface parts in the second state,
wherein the device comprises control means for addressing the individual surface parts, and
wherein the display is suitable for retaining a certain image when, after placing said image, a power supply to the display is virtually stopped.

52. Assembly according to claim 51, wherein the display is an electroforetic display, an electrowetting display, an LCD or nano LCD.

53. Assembly according to claim 51, wherein the addressable surface parts are placed in columns and rows for forming a matrix display for displaying changing and/or moving images.

54. Assembly according to claim 52, wherein the addressable surface parts comprises an electroluminescent element, preferably a LED, preferably an organic LED, such as a polymer LED.

55. Assembly according to claim 51, wherein the device comprises a receiver for receiving data for displaying on the display, wherein the receiver is connected to the control means for transmitting the data from the receiver to the control means, wherein the receiver preferably comprises a wireless receiver, preferably a radio receiver, and wherein the receiver is preferably situated in the holder.

56. Assembly according to claim 51, wherein the assembly further comprises a data processing device, such as for instance a computer, for exchanging data with the individual or collective devices, preferably over a network, preferably the internet, preferably wireless, preferably over an IP protocol.

57. Assembly according to claim 51, wherein at least one of the one or more devices comprises a sensor for perceiving the surroundings of said device, the motion and/or direction of at least the wind surface of said device, wherein the sensor is connected to the control means of said device for transmitting a signal from the sensor to the control means, and wherein the control means are adapted for controlling the display in dependency on the sensor's signal.

58. Assembly according to claim 57, wherein the sensor comprises a position sensor, velocity sensor, acceleration sensor, a person detection sensor for detecting persons in the vicinity of the device or a motion sensor for detecting the motion of the information carrier with respect to the holder.

59. Assembly according to claim 57, wherein the control means are adapted for forwarding the sensor's signal or a derived quantity thereof to a data processing device, preferably for controlling the various devices for a multi-screen presentation of changing and/of moving images and/or the dynamic division of parts of a full picture over several displays.

60. Assembly according to claim 51, wherein the device further comprises means for generating electric power from a force exerted by the wind on the wind surface, preferably means for generating electric power from the movement of at least the wind surface under the influence of the wind, wherein the means for generating electric power can be connected to means for energy storage, such as for instance a battery, the display and/or the control means for supplying electric power thereto.

61. Assembly according to claim 60, wherein the wind surface of the device is rotatably connected to the holder and wherein the means for generating electric power comprise a rotating generator or dynamo, and wherein the wind surface preferably forms a wind turbine, a windmill or a rotor.

62. Assembly according to claim 51, wherein the display is bendable and preferably flexible, wherein the display is preferably made of an electronic fabric, preferably woven from yarn-shaped material comprising an electroforetic material.

63. Assembly according to claim 51, wherein the information carrier comprises a transparent housing for the display, wherein the housing preferably comprises a sealing protective layer for protecting the display from air, water and/or water vapour, and wherein the protective layer preferably comprises a transparent inorganic or organic coating or cover plate.

64. Assembly according to claim 51, wherein the information carrier is a flag or banner, wherein the flag or banner, preferably on two sides, is provided with the display, and wherein the holder comprises a flagpole and/or banner arm.

65. Assembly according to claim 64, wherein the information carrier is made of a flexible and/or elastic material, which material preferably at least partially surrounds the display, wherein the information carrier preferably comprises an electricity conducting and preferably elastic polymer for connecting the display to the control device.

66. Assembly according to claim 65, wherein the display can be retracted in the holder, preferably in the banner arm.

67. Assembly according to claim 65, wherein the edges of the display device are provided with an enveloping, gas-filled layer, such as a cushion or tube for protection against bumping.

68. Assembly according to claim 65, wherein the wind surface is at least partially provided with a piezoelectric foil situated in the wind surface, for generating electric power from the wind surface blowing in the wind.

69. Assembly according to claim 65, wherein the holder and/or the information carrier are provided with piezoelectric elements for absorbing a tensile force exerted by the wind on the wind surface, and for converting said tensile force in electric power.

70. Assembly according to claim 51, wherein the information carrier comprises a rotor, preferably a savonius-type rotor, which is placed so as to be rotatable about a substantially vertical axis of rotation, wherein the rotor has a substantially S-shaped cross-section in a direction substantially perpendicular to the axis of rotation of the rotor, and wherein the display preferably substantially follows the aerodynamic shape of the wind surface.

71. Device comprising an information carrier and a holder for the information carrier, wherein the information carrier is movably connected to at least a portion of the holder,
wherein the information carrier comprises a wind surface for moving at least the wind surface under the influence of the wind,
wherein the wind surface comprises a display comprising a series of addressable surface parts situated in the surface, which surface parts can be switched to a first and a second state, wherein the surface parts in the first state visually differs from the surface parts in the second state,
wherein the device comprises control means for addressing the individual surface parts, and
wherein the display is suitable for retaining a certain image when, after placing said image, a power supply to the display is virtually stopped.

72. Device according to claim 71, wherein the display is an electroforetic display, an electrowetting display, an LCD or nano LCD.

73. Device according to claim 71, wherein the addressable surface parts are placed in columns and rows for forming a matrix display for displaying changing and/or moving images.

74. Information carrier and/or holder suitable and intended for use in a device according to claim 71.
